(19) United States
(12) Patent Application Publication
(10) Pub. No.: US 2011/0186009 A1
(43) Pub. Date: Aug. 4, 2011

(54) PhanNam Engine

(76) Inventor: Nam Thanh Phan, Ho Chi Minh (VN)

(21) Appl. No.: 12/698,105

(22) Filed: Feb. 1, 2010

(51) Int. Cl. F02B 57/08

(52) U.S. Cl. 123/44 A

(57) ABSTRACT

A PhanNam engine includes a crankshaft which rotates around its axis. Impeller is installed on the engine block and rotates around main axis of engine, the impeller has 4 combustion chambers. A piston slides inside cylinder and operation associates with crankshaft and impeller. Gear ratio between impeller and crankshaft is 1:4, which means that piston carries out four compression strokes and ignition plug will be activated four times to generate four work generation times.

### BACKGROUND OF THE INVENTION

This invention relates to internal combustion engines, especially four stroke internal combustion engines which have expsosion by ignition (SI). The basic components of an internal combustion engine are well known in the art and include: the engine block, cylinder heads, cylinders, pistons, valves, crankshaft and cam-shaft, connecting rod. The cylinder heads, cylinders and tops of the pistons typically form combustion chambers into which fuel and oxidizer (e.g., air) is introduced and combustion takes place. In all internal combustion engines, useful work is generated from the hot, gaseous products of combustion acting directly on moving surfaces of engine, such as the top or crown of a piston to create reciprocating motion of piston. This reciprocating motion of piston is transferred to rotary motion of crankshaft via connecting rod.

### SUMMARY OF THE INVENTION

This invention offers a new kind of internal combustion engine.

Cycles of work generation of the engine is not completely separated but phase of cycles are overlaped each others, which means the burst and release process of current cycles will semultaneously occur with the feeding stroke of next work generation cycle. Each rotation of the engine shaft will include four work generation cycles.

A PhanNam engine includes a crankshaft which rotates around its axis. Impeller is installed on the engine block and rotates around main axis of engine, the impeller has 4 combustion chambers. A piston slides inside cylinder and operation associates with crankshaft and impeller. Gear ratio between impeller and crankshaft is 1:4, which means that piston carries out four compression strokes and ignition plug will be activated four times to generate four work generation times.

A PhanNam engine is based on background of four stroke combustion engine. The remarkable charateristic of PhanNam engine is that the moment of ignition activation can be actively adjusted to generate work. The generated work will directly effect on the main shaft of engine without via any intermediate gear. In this occasion, piston is only used to create the compression force to fuel and not transfer the generated work. On the other hand, combustion products will be automatically released through exhaust line without exhaust valve.

### BRIEF DESCRIPTION OF THE DRAWINGS

FIG. 1 describe main views of invention engine.

FIG. 2 describe the structure of the invention engine in the form of 3D.

FIG. 3-9 describe operation cycle of combustion chamber 1.

### DETAILED DESCRIPTION OF THE INVENTOR

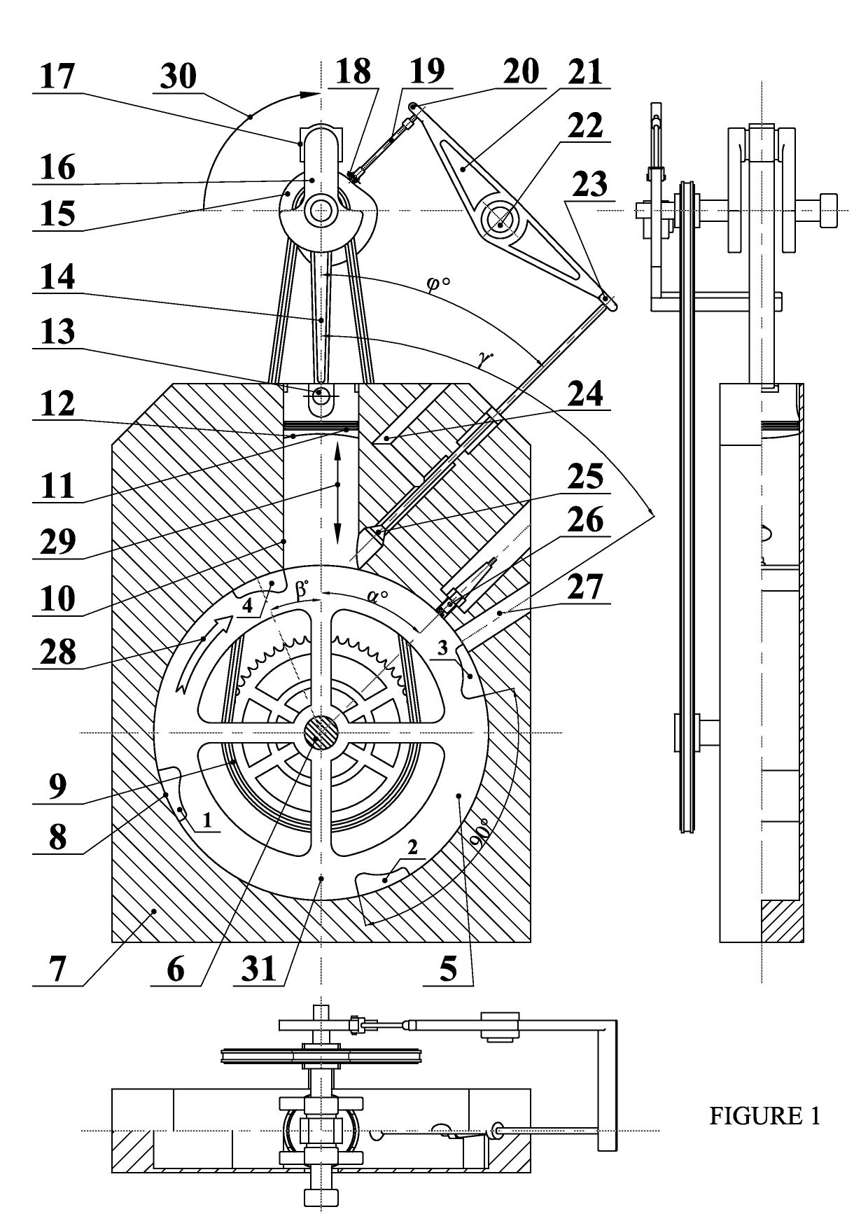

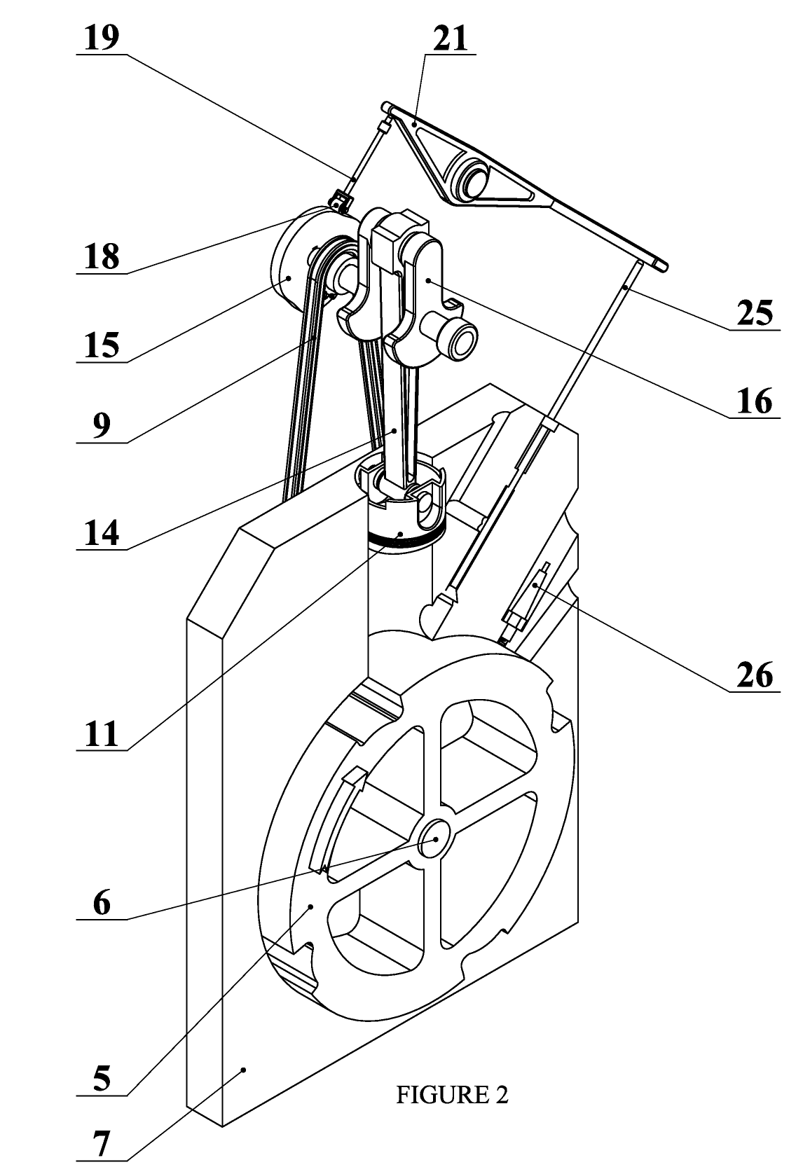

See FIG. 1-2, the engine block 7 is main component of PhanNam engine. It is a structure frame to assemble engine with engine pedestal (do not perform) and also used to assemble other parts of the engine.

Cylinder 10 is a cylindrical hole extending from top of the engine block 7 to the impeller chamber 8. Cylinder 10 is utilized to install piston 11. The impeller 5 is inserted into the impeller chamber 8. The surface of cylinder 10 and the impeller chamber 8 are processed to create a glossy and precise surface.

Piston 11 slides along central axis of cylinder 10. The bottom section 12 of piston 11 is generated in the curved surface which has the same radius of the curved surface of impeller chamber 8. The outer surface of piston 11 is generally processed in the size of cylinder hole 10 and processed to create grooves for assembling piston rings (do not perform) to seal clearance between piston and cylinder.

Connecting rod 14 is installed with piston at its head 13 and installed with crankshaft 16 at its head 17. Association of connecting rod 14 with piston 11 and crankshaft 16 in order to convert rotating motion (in the direction of arrow 30, FIG. 1) of crankshaft 16 into translational motion (in the direction of arrow 29, FIG. 1) of piston

Although this embodiment shows that piston 11 associated with crankshaft 16 through connecting rod 14, but a person skilled in art will know that all other methods can be made to connect piston 11 to crankshaft 16 also in the scope of this invention.

The engine block 7 also includes fuel line 24 crossing with cylinder 10. This path includes feed check valve 25 installed at the end of fuel line 24. This feed check valve 25 allows the fuel mixture only to flow one direction from the fuel line 24 into cylinder 10. Although valve 25 which is feed check valve, is mentioned here but any design that is suitable for this application can be used to replace, that is feed check valve 25 would be a mushroom valve.

The engine block 7 also includes a ignition plug 26 deflected an angle a to central line 31. The ignition plug 26 will be activated by control device (do not perform) to combust fuel mixture compressed in combustion chamber just in time when combustion chamber moves to the location of the ignition plug. In addition, the engine blocks also has exhaust line 27 behind the location of the ignition plug, this exhaust line 27 is used to exhaust combustion products from combustion chamber.

Although this embodiment describes spark ignition engine (SI) and use gas for fuel, but a person skilled in art will know that a PhanNam engine in this invention can be operated via other multiple fuels than gas, such as hydrogen and natural gas.

The impeller 5 includes four combustion chambers (1, 2, 3, 4) on its the cylinderical surface. This four combustion chambers are deflected 90° each others on the impeller and specially formed to create rotation tendency of the impeller 5 in the direction of arrow 28 when mixture fuel is burned in the combustion chamber. This impeller 5 is fixed on the main shaft 6 of the engine and installed into the impeller chamber on the engine block 7. The impeller 5 will rotate around axis of the main shaft 6. Four combustion chambers on the impeller and internal surface of the impeller chamber 8 will together create four moving combustion chambers. Although this embodiment describes engine which has four combustion chambers, but a person skilled in art will know that a PhanNam engine in this invention may have less or more combustion chambers (e.g. the engine has one, two, five or six combustion chambers, . . . ).

Cam 15 is installed on the crankshaft 16 and rotate in the same speed with crankshaft 16. The cam 15 contacts with roller 18 of the push rod 19, the other head of the push rod 19 contacts with head 20 of the rocking lever 21. Head 23 of the rocking lever 21 contacts with feed check valve 25. The push rod move translationally on its center line, the rocking lever will shake around the center of the pivot pin 22. The cam is used to control opened and closed state of the feed check valve 25 that is opened in 180° period and closed in 180° period. That means, the cam rotate a circle (360°) while the feed check valve 25 will close in one half circle of the cam (180°) and open in one half circle of the cam (180°).

Although in this embodiment, the cam is installed on the crankshaft, but a person skilled in art will know that all other installation methods which ensure the cam 15 rotates the same speed with the crankshaft 16 is in range of this invention. Example: the cam is installed in the camshaft, the camshaft and crankshaft are associated together via the chain gear having gear ratio 1:1 to ensure that the cam rotates in the same speed with crankshaft.

The main shaft 6 and crankshaft 16 is connected through the chain gear 9. When the main shaft 6 rotates a round (the impeller 5 rotates a round), the crankshaft will rotate four rounds, that mean the gear ratio between the main shaft 6 and crankshaft 16 is 1:4. Although in this embodiment, the main shaft 6 is connected to crankshaft 16 through the gear chain 9, but a person skilled in art will know that all other methods may be used to connect the main shaft 6 and the crankshaft 16 is in scope of this invention (mean that it can be alternatively connected by chain gear, belt driver, gear set, . . . )

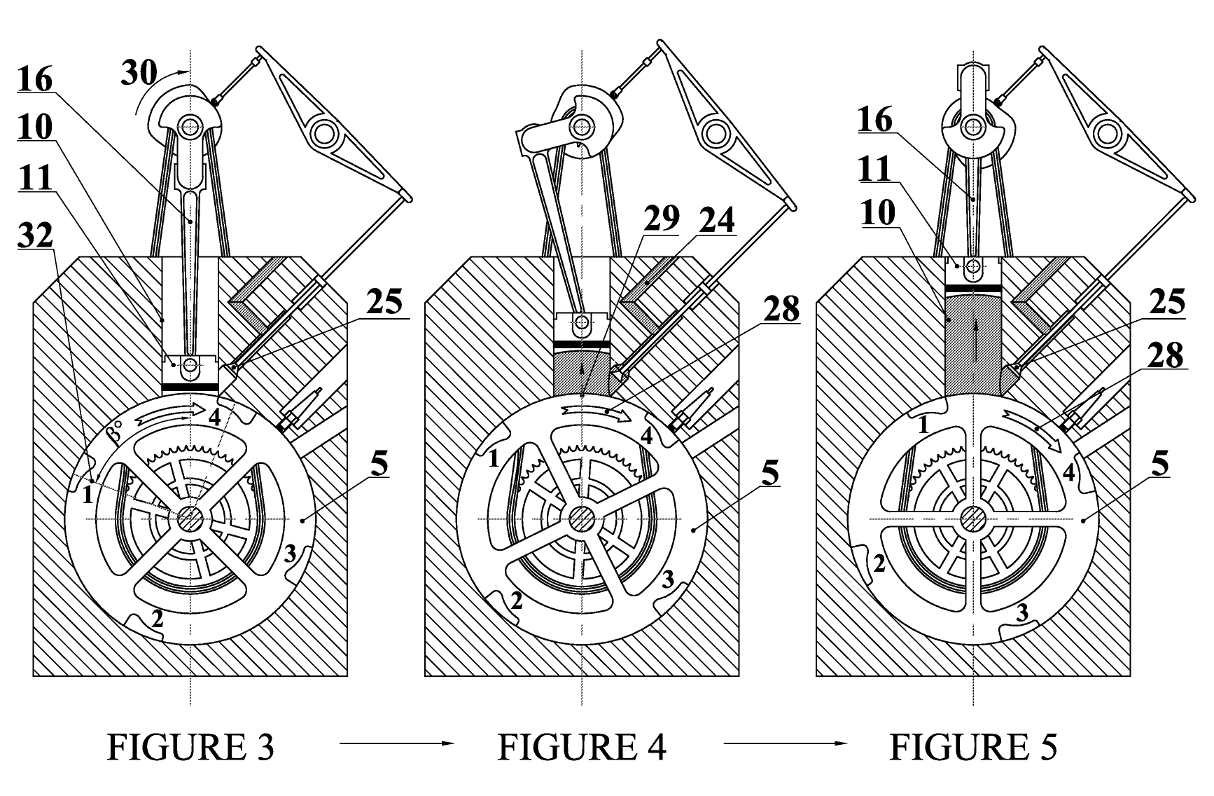

FIG. 3-5 describe the feeding stroke of PhanNam engine. Beginning of the feeding stroke, the feed check valve 25 is in closed position, the center line 32 of the combustion chamber 1 is deflected with the center line 31 of the cylinder 10 at an angle β. The piston 11 is at the bottom dead center, this is the position where the piston 11 is the farthest from the center line of crankshaft 16. Crankshaft starts rotating in the direction of arrow 30, piston 11 goes up (in the direction of arrow 29—FIG. 4), the feed check valve 25 is also opened to let the mixture of fuel from the fuel line 24 overflow into cylinder 10. At the same time, the impeller also rotates in the direction of arrow 28 and the combustion chamber 1 also moves. The feed check valve only opens in the stroke 180° of the crankshaft 16, in other words, when the crankshaft 16 is turned 180°, piston 11 is at the top dead center and the feed check valve 25 is closed completely. At this time, the mixture of fuel is filled in the cylinder 10.

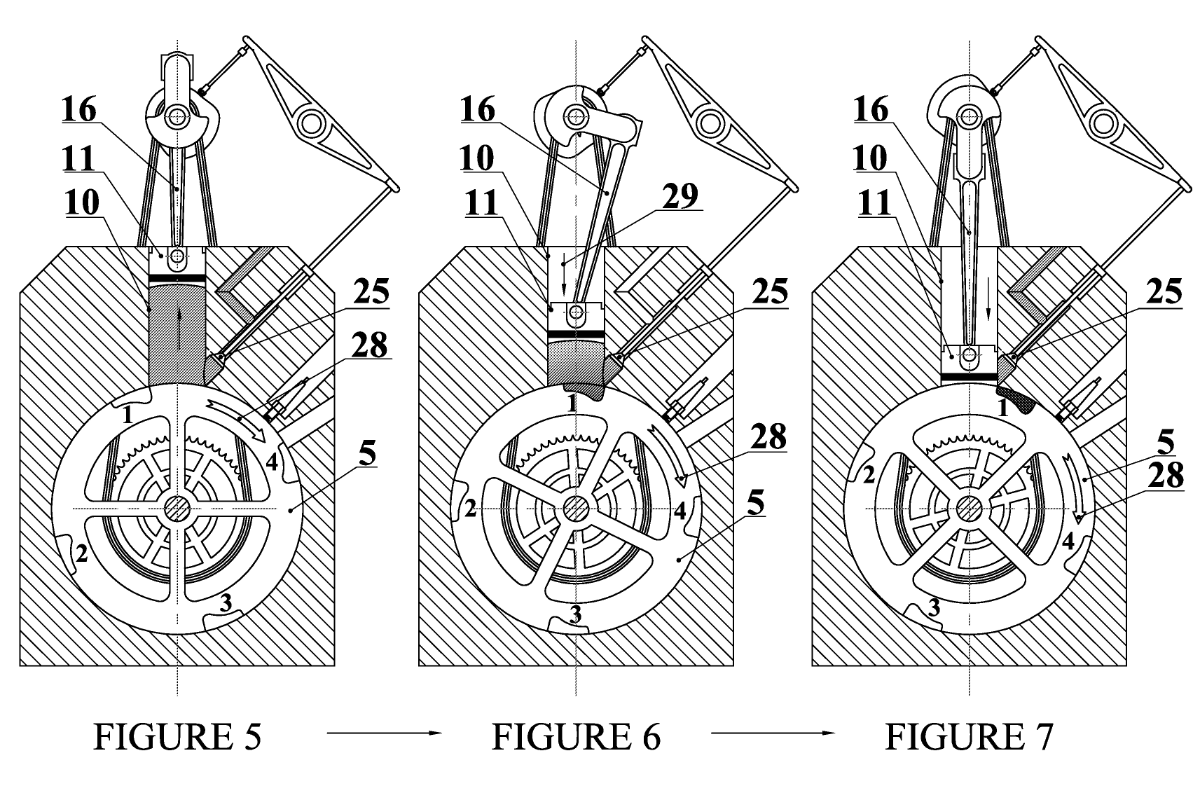

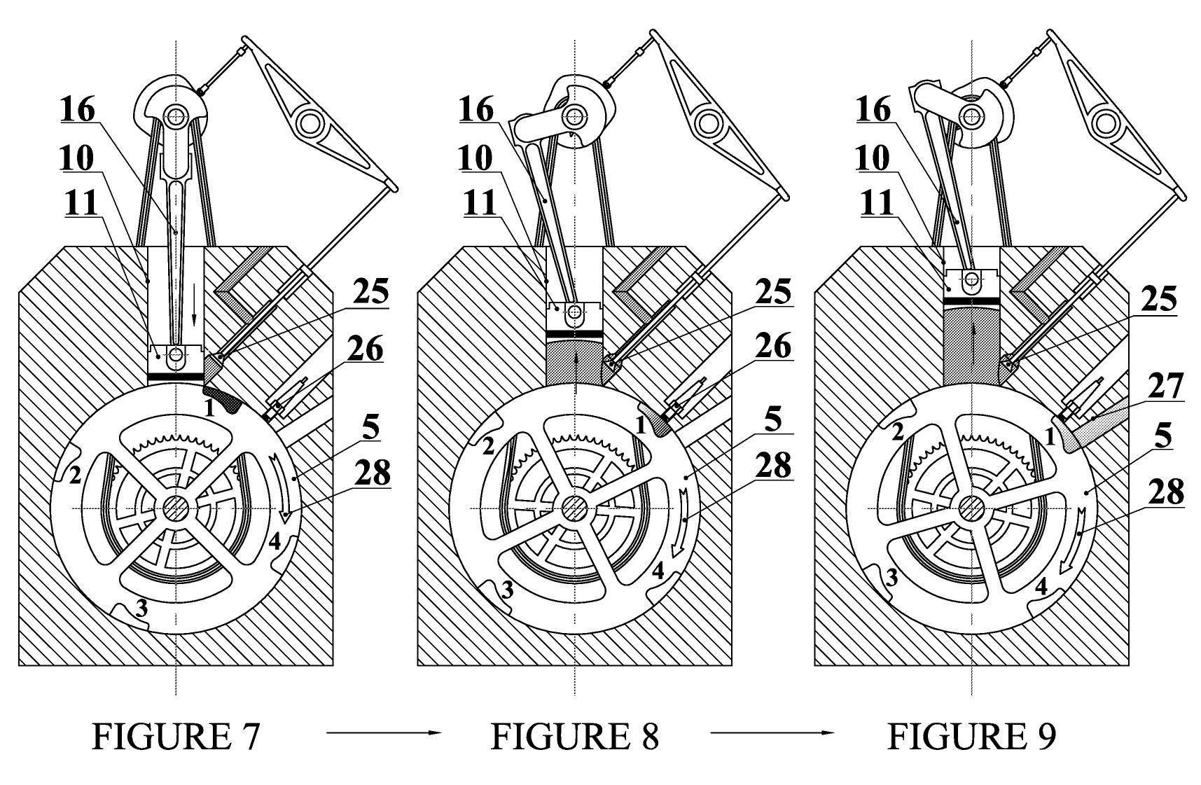

FIGS. 5-7, describe the compression stroke of PhanNam engine. The feed check valve 25 is closed completely in this compression stroke. The combustion chamber 1 begins contacting to cylinder 10. Crankshaft 16 continue to rotate the next ½ round, piston 11 moves from the top dead center to the bottom dead center (in the direction of arrow 29—FIG. 6) to press the mixture of fuel into the combustion chamber 1. Ending of the compression stroke, piston 11 is at the bottom dead center, the whole mixture of fuel is being pressed into the combustion chamber 1. At this time, the impeller 5 turns in the direction of arrow 28 and makes the combustion chamber 1 separated from cylinder 10 (FIG. 7).

FIGS. 7-9 describe the combustion stroke and exhaust stroke of PhanNam engine. The impeller 5 continues to rotate in the direction of arrow 28 and brings the combustion chamber 1 to contact with the ignition plug 26. The ignition plug 26 is activated to creates the electrical spark to burn the whole mixture of fuel which is compressed in the combustion chamber 1. Because of the special shape of the combustion chamber, as the combustion occurs that simulatneously create a pressing force which tends to make the impeller 5 continue rotating in the direction of arrow 28. This is the moment that work is generated in PhanNam engine. Then the combustion chamber 1 will contact with the exhaust line 27 to exhausts whole combustion products out (FIG. 9). Otherwise, the combustion and exhaust processes of the combustion chamber 1 happen at the same time with the feeding stroke of the combustion chamber 2. That mean, when the impeller 5 turns and separates the combustion chamber 1 from cylinder 10, the crankshaft starts a new cycle, piston 11 goes from the bottom dead center to the top dead center and the feed check valve 25 is also opened to let the mixture of fuel overflow cylinder 10.

According to the above operating principle, a round of the engine shaft 6 (the impeller) will include four work generating cycles. Meaningly these work generating cycles don't happen independently but they have overlap of phases, that mean, the shaft 6 of engine rotate a round, the crankshaft 16 will rotate four rounds to takes four feeding strokes and four compression strokes. The combustion and exhaust process of the current work generating cycle will happen at the same time with the feeding stroke of the next work generating cycle.

### PARTS LIST

Combustion chamber 1, 2, 3, 4
Impeller 5
Main shaft 6
Engine block 7
Impeller chamber 8
Chain gear 9
Cylinder 10
Piston 11
Bottom surface 12 of piston
Heads of connecting rod 13, 17
Connecting rod 14
Cam 15
Crankshaft 16
Roller 18
Push rod 19
Rocking lever 21
Head of rocking lever 20, 23
Pivot pin 22
Fuel line 24
Feed check valve 25
Ignition plug 26
Exhaust line 27

What is claimed is:

1. A PhanNam engine comprises:
A engine block is structure frame to install the orther parts of the engine.
A the crankshaft turns around the center line of it. A cam is installed on the the crankshaft.
A impeller turns around the main shaft of engine. The impeller has four chambers in the deflection 90° to each others. The impeller is connected to the crankshaft with transmission ratio 1:4.
A piston slides in a cylinder and connected with the crankshaft so that piston takes a stroke (up and down) in the same round of the crankshaft.

2. The engine of claim 1 compises a feeding line which is connected with cylinder. This feeding line have a feed check valve which is opend in one half circle of the cam (180°) and closed in one half circle of the cam (180°).

3. The engine of claim 1 comprises a ignition plug deflected with the center line of the cylinder at an angle α°<90°.

4. The engine of claim 1 comprise a exhaust line behind ignition plug. This exhaust line is deflected with the center line of the cylinder at an angle γ in the condition of α°<γ°<90°. The burn products are automatically released out without exhaust valve.
